(19) United States
(12) Patent Application Publication
(10) Pub. No.: US 2014/0321157 A1
(43) Pub. Date: Oct. 30, 2014

(54) BACK LIGHT UNIT WITH LIGHT GUIDE PLATE PREVENTING DARK AREA BETWEEN LEDS

(71) Applicant: HB TECHNOLOGY CO., LTD., Asan-si (KR)

(72) Inventors: Choongyop RHEW, Hwaseong-si (KR); Daisoung PARK, Hwaseong-si (KR); Seungkeun LEE, Hwaseong-si (KR)

(73) Assignee: HB TECHNOLOGY CO., LTD., Asan-si (KR)

(21) Appl. No.: 14/212,544

(22) Filed: Mar. 14, 2014

(30) Foreign Application Priority Data
Apr. 26, 2013 (KR) 10-2013-0046455

(51) Int. Cl. F21V 8/00

(52) U.S. Cl. CPC G02B 6/0018; G02B 6/0073
USPC 362/608

(57) ABSTRACT

A backlight unit with a light guide plate preventing a dark area between LEDs is provided, wherein dark area-preventing patterns may adequately compensate for the brightness in a gap between the LEDs that may be a dark area even under the condition that the gap is relatively large and greater than or equal to the width of an LED and thus, uniform brightness may be obtained without an occurrence of the dark area. Accordingly, the number of the LEDs may decrease and thus, a large-sized backlight unit may be fabricated with a relatively low cost.

### CROSS REFERENCE

Applicant claims foreign priority under Paris Convention to Korean Patent Application No. 10-2013-0046455 filed 26 Apr. 2013, with the Korean Intellectual Property Office, where the entire contents are incorporated herein by reference.

### BACKGROUND OF THE INVENTION

1. Field of the Invention

The present invention relates to a backlight unit with a light guide plate preventing a dark area between light emitting diodes (LEDs), and more particularly, to a technology for forming a plurality of dark area-preventing patterns at a position of a light guide plate corresponding to the gap between LEDs of an edge light type backlight unit and for obtaining uniform brightness without an occurrence of a dark area.

2. Description of the Related Art

In general, a light guide plate may refer to a plate providing a path through which a light irradiated from a light source is uniformly scattered and diffused and be applicable to a backlight unit (BLU) used for a light-receiving flat panel display, e.g. a liquid crystal display, or a luminous signboard.

For example, Japanese Patent Laid-Open Publication No. 2004-325959 discloses a liquid crystal backlight device using a conventional backlight device by which lights incident from an LED to a light guide plate may be reflected upwards by a fine reflection pattern formed on a lower plane of the light guide plate and be emitted to a liquid crystal panel on an upper portion of the light guide plate through a diffuser.

However, because most of the light irradiated from the LED may proceed frontward and thus, a relatively small amount of the light may proceed laterally, the light irradiated from the LED may be non-uniformly provided to the light incidence plane of the light guide plate and accordingly, a dark area may be formed between the LEDs and non-uniform brightness may ensue.

Thus, it may be required to dispose the LEDs at a narrower interval to prevent an occurrence of the dark area, which may incur a higher cost and cause limitations in design.

When the light efficiency of an LED increases, the number of LEDs disposed on a side plane of the light guide plate may decrease. However, when the number of the LEDs decreases, the gap between the LEDs may be larger and consequently, brightness may become uneven further.

To solve such an issue, technologies for forming a saw-toothed pattern on an incidence plane of the light guide plate for a conventional small-sized mobile device or a monitor have been introduced.

When applying the technology to a large-sized television (TV) whose size exceeds that of a monitor, the gap between the LEDs may be required to be much larger. However, the conventional simple saw-toothed pattern may not adequately eliminate a dark area and cause a secondary issue of non-uniform illumination intensity of a surface light source due to the change in the process condition for the saw-toothed pattern.

Accordingly, to provide a large-sized backlight unit in a more economically efficient manner, there is a desire for a technology for allowing a light guide plate to evenly diffusing the light incident from LEDs even under the condition that the gap between the LEDs is relatively large, which may be greater than or equal to the width of an LED, and for preventing an occurrence of a dark area.

### SUMMARY OF THE INVENTION

The intent of the present invention, for the purpose of solving the drawbacks aforementioned, is to compensate the brightness in the gap between LEDs, which may be a dark area, even under the condition that the gap between the LEDs is relatively large and greater than or equal to a width of an LED, obtain uniform brightness without an occurrence of the dark area, and reduce the number of the LEDs thus, to fabricate a large-sized backlight unit with a low cost.

To achieve the said goals, the present invention shall provide a backlight unit including a plurality of LEDs disposed on a bar-shaped circuit board and separated from one another at a predetermined interval and a light guide plate having a plurality of light guide patterns formed on one portion of the light guide plate that reflect, refract, or scatter lights incident from the LEDs to disperse the light in numerous directions and having a plurality of dark area-preventing patterns formed at a position corresponding to the gap between the LEDs to prevent a dark area between the LEDs. The dark area-preventing patterns are to be engraved with a relatively greater depth than that of the said light guide patterns to reflect, refract, or scatter again the lights passing through the dark area among lights dispersing in the numerous directions by the light guide patterns, to compensate for brightness in the dark area, and to prevent an occurrence of the dark area.

The gap between the LEDs is preferred to have a size greater than or equal to the width of an LED.

The dark area-preventing patterns are preferred to be formed at an edge of the light guide plate that corresponds to the gap between the LEDs to a depth direction identical to that of the light guide patterns.

The dark area-preventing patterns are preferred to be formed on an incidence plane of the light guide plate that corresponds to the gap between the LEDs to a depth direction perpendicular to that of the light guide patterns.

The dark area-preventing patterns are preferred to be formed at a position departing from a radiation angle across which the lights incident from each LED spread and reach.

The dark area-preventing patterns are preferred to be formed in a blank space present between the area of the light guide patterns and the said edge of the light guide plate or formed at a position covered by the bezel provided around the border when assembling a backlight unit.

When the light guide patterns are engraved, the dark area-preventing patterns are preferred to be formed up to 2 or more times of that of the light guide patterns.

When the light guide patterns are embossed, the dark area-preventing patterns are preferred to be engraved with a depth that is 100 μM or more.

The dark area-preventing patterns are preferred to be formed using at least one of laser processing, hot stamping, injection molding, extrusion, and ultrasonic machining.

According to the present invention, brightness in a gap between LEDs, which may be a dark area, may be compensated even under the condition that the gap between the LEDs is relatively large and greater than or equal to the width of an LED, uniform brightness may be obtained without an occurrence of the dark area, and the number of the LEDs may decrease and thus, a large-sized backlight unit may be fabricated with a low cost.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIGS. 1A through 1C are a perspective view, a cross-sectional view, and a planar view, respectively, of the core part of a backlight unit, illustrating a light guide plate and LEDs according to the Embodiment 1 of the present invention;

FIGS. 2A through 2C are diagrams illustrating a dark area-preventing effect by dark area-preventing patterns in the light guide plate illustrated in FIGS. 1A through 1C;

FIG. 3 is a graph plotting brightness in a dark area in comparison to a bright area, according to the depth of dark area-preventing patterns in a light guide plate according to the Embodiment 1 of the present invention;

FIGS. 4A through 4C are a perspective view, a cross-sectional view, and a planar view, respectively, of the core part of a backlight unit, illustrating a light guide plate and LEDs according to the Embodiment 1 of the present invention; and

FIGS. 5A through 5F are illustrates another example of dark area-preventing patterns in a light guide plate according to the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here.

### Embodiment 1

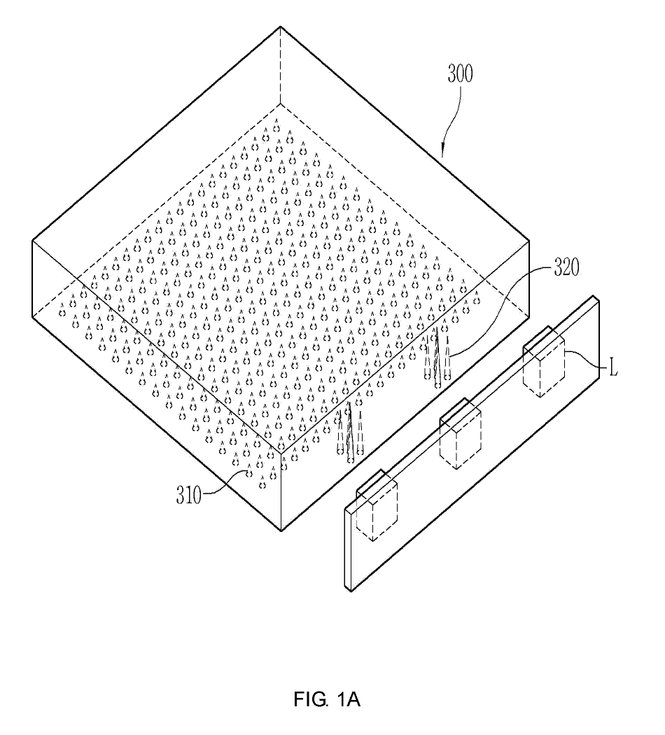

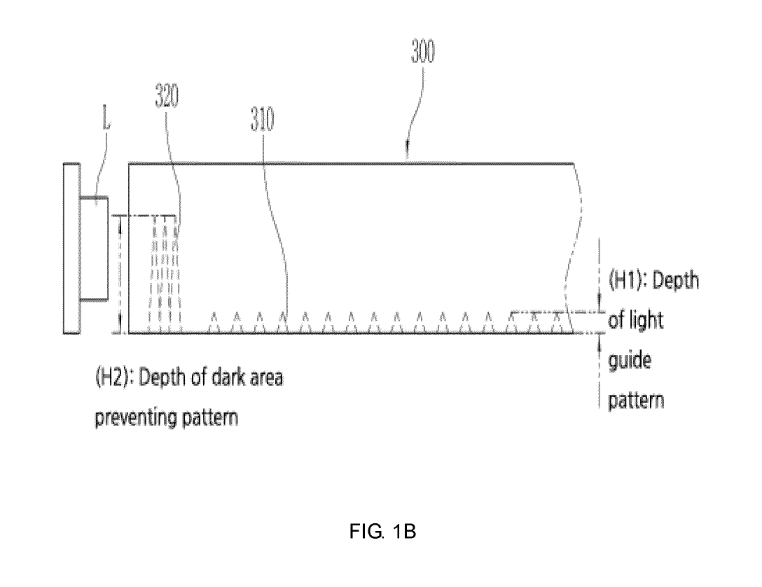

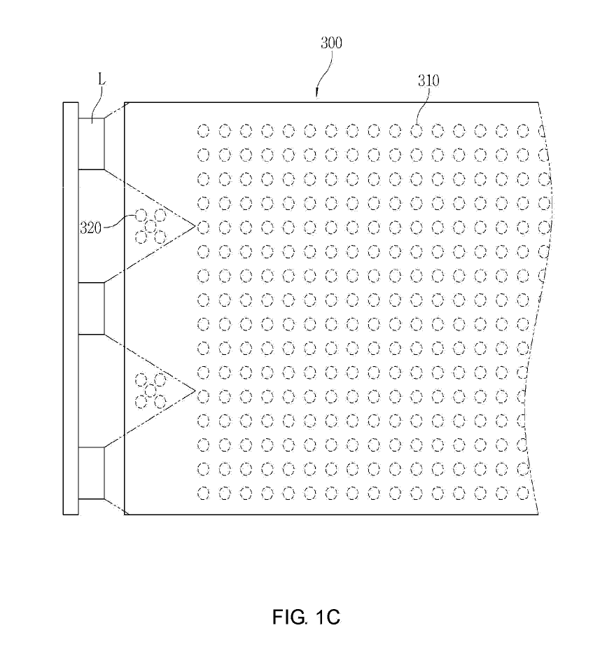

FIGS. 1A through 1C are a perspective view, a cross-sectional view, and a planar view, respectively, of the core part of a backlight unit, illustrating a light guide plate 300 and LEDs (L) according to the Embodiment 1 of the present invention.

Referring to FIGS. 1A to 1C, the backlight unit according to the Embodiment 1 of this invention shall have dark area-preventing patterns 320 formed at an edge of the light guide plate 300 corresponding to the gap between the LEDs (L) to prevent a dark area.

Here, the light guide plate 300 may be made of transparent synthetic resin allowing a light to penetrate in that it may be fabricated combining at least one of high-transparent silicone resin, urethane, polystyrene (PS), polycarbonate (PC), polyethylene terephthalate (PET), styrene methyl methacrylate (MS), and polymethyl methacrylate (PMMA).

A side plane facing the LED light source (L) among the planes of the light guide plate 300 is to be the incidence plane. Either the upper or lower plane of the light guide plate 300 shall be engraved with light guide patterns 310 to reflect an incident light toward the liquid crystal panel (not shown) changing it to a surface light source.

A plurality of the said LED light sources (L) shall be disposed on a bar-shaped circuit board and separated from one another at a predetermined interval. The gap between the said LED light sources (L) is preferred to have a size greater than or equal to the width of each LED light source (L).

The dark area-preventing patterns 320 are preferred to be formed in a blank space between the area of the light guide patterns 310 and the edge of the light guide plate 300, or formed at a position that is to be covered by a bezel provided around the border when finally assembling a backlight unit.

More particularly, the dark area-preventing patterns 320 shall be engraved with a depth (H2) greater than the depth (H1) of the light guide patterns 310 so that the brightness in the gap between the LEDs (L), which may be a dark area, may be compensated preventing a dark area from occurring. A more detailed description will be provided hereinafter.

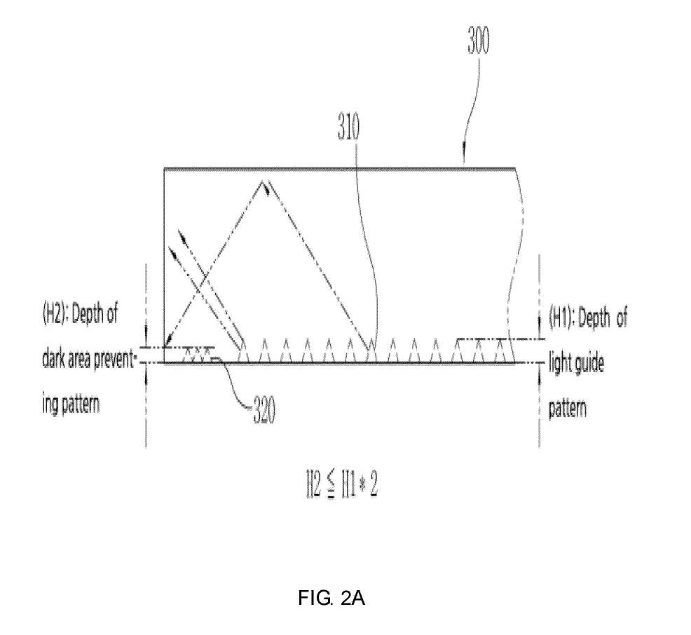

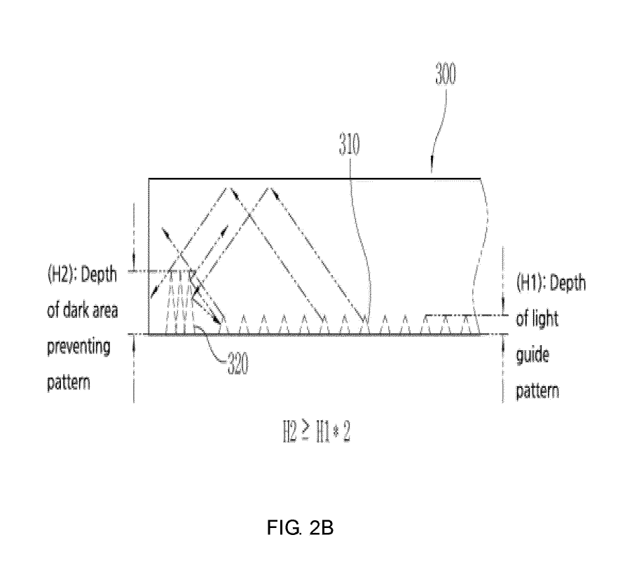

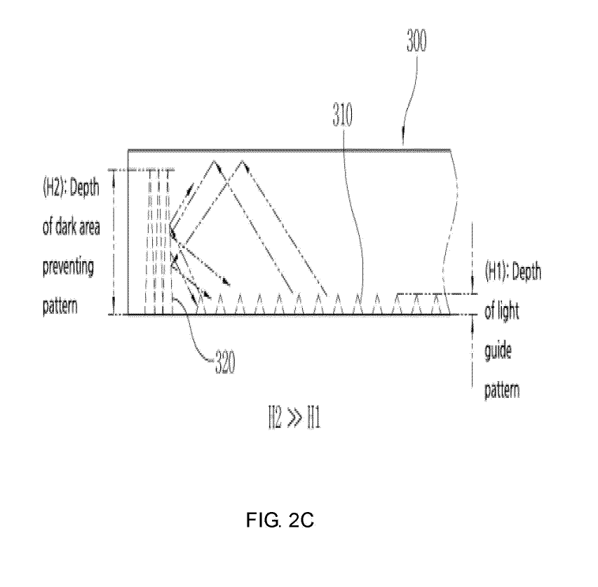

FIGS. 2A through 2C are diagrams illustrating a dark area-preventing effect by dark area-preventing patterns 320 of a light guide plate 300 illustrated in FIGS. 1A through 1C.

Referring to FIG. 2A, lights incident to the light guide plate 300 may be reflected, refracted, or scattered, and dispersed in numerous directions by the light guide patterns 310.

Here, when dark area-preventing patterns 320 are formed of which depth (H2) is smaller than the depth (H1) of the light guide patterns 310 disposed at an edge of the light guide plate 300 corresponding to the gap between LED light sources (L), there may be a low possibility that a light passing through a dark area among lights dispersing in numerous directions by the light guide patterns 310 collides with the dark area-preventing patterns 320 and thus, the dark area is likely to occur because the gap between the LEDs (L) relatively lacks the amount of light.

Referring to FIGS. 2B and 2C, when the dark area-preventing patterns 320 are formed with a depth (H2) 2 or more times greater than the depth (H1) of the light guide patterns 310 at the edge of the light guide plate 300 corresponding to the gap between the LED light sources (L), there may be a high possibility that the light passing through the dark area among the lights dispersing in the numerous directions by the light guide patterns 310 collides with the dark area-preventing patterns 320 because the depth (H2) of the dark area-preventing patterns 320 is relatively larger than the depth (H1) of the light guide patterns 310.

In such a case, the light passing through the dark area is to collide with the dark area-preventing patterns 320, and be intensively reflected, refracted, or scattered again by the dark area-preventing patterns 320 so that the dark area-preventing patterns 320 may emit a stronger light, in comparison to the light guide patterns 310, and may function as a virtual LED light source.

A conventional simple saw-toothed pattern may not completely eliminate the dark area when the gap between the LEDs (L) is designed to be larger for a backlight unit applicable to a TV of a large size surpassing a size of a monitor. However, the backlight unit according to the present invention may fully compensate for brightness in the dark area by the dark area-preventing patterns 320 even under the condition that the gap between the LEDs (L) becomes larger to be greater than or equal to the width of an LED (L) and thus, may obtain uniform brightness without an occurrence of the dark area.

Referring back to FIG. 1C, the dark area-preventing patterns 320 are preferred to be formed at a position departing from a radiation angle across which the lights incident from each LED (L) at the edge portion of the light guide plate 300 corresponding to the gap between LED light sources (L) spread and directly reach in that, when the dark area-preventing patterns 320 are formed within a radiation angle portion of each LED (L), the light incident from each LED (L) may be intensively reflected, refracted, or scattered again by the dark area-preventing patterns 320 and thus, an excessively bright area, if anything, may be formed in a portion of the dark area-preventing patterns 320.

Also, it is desired that the dark area-preventing patterns 320 are engraved up to a depth 2 or more times that of the depth of the light guide pattern 310, using at least one method of laser processing, hot stamping, injection molding, extrusion, and ultrasonic machining. A more detailed description will be provided hereinafter.

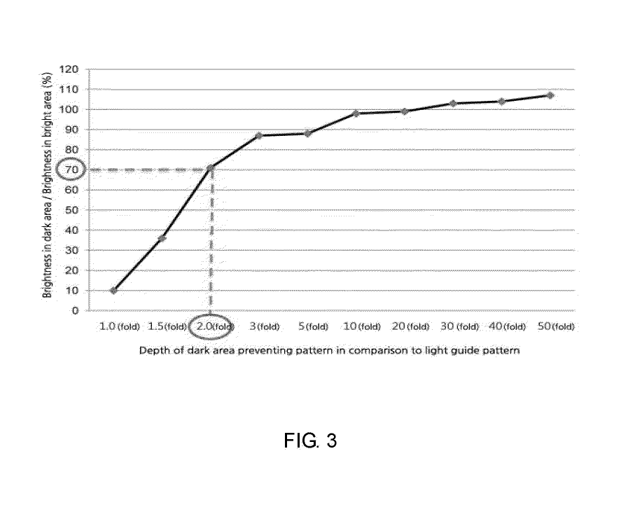

FIG. 3 is a graph plotting the brightness in a dark area in comparison to the bright area based on a depth of dark area-preventing patterns 320 in a light guide plate 300 according to the Embodiment 1 of the present invention.

Referring to FIG. 3, when the dark area-preventing patterns 320 have a depth deeper by a factor of greater than or equal to two compared to the depth of light guide patterns 310, the brightness in the dark area is to become greater than or equal to 70% of that of the bright area.

In general, when the brightness in the dark area is greater than or equal to 70% of that of the bright area in the light guide plate 300 provided to a backlight unit, the brightness may be determined to be uniform. Thus, to provide a backlight unit having uniform brightness, it may be required to form the dark area-preventing patterns 320 in the light guide plate 300 to have a depth deeper by a factor of greater than or equal to two compared to the depth of the light guide patterns 310.

For example, the depth of the light guide patterns 310 engraved may be generally 50 μm. Thus, it may be required to form the dark area-preventing patterns 320 to have a depth greater than or equal to 100 μm, which is greater than or equal to two times of the depth of the light guide patterns 310. When the light guide patterns 310 are embossed, it may be required to form the dark area-preventing patterns 320 as an engraved pattern to have the depth greater than or equal to 100 μm.

### Embodiment 2

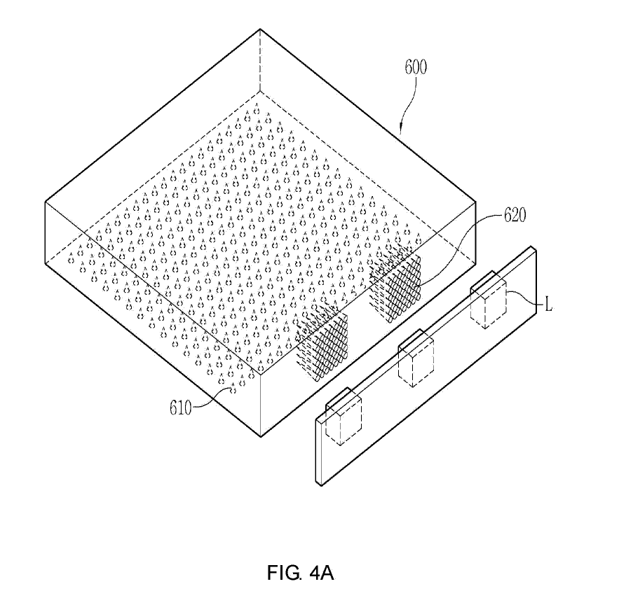

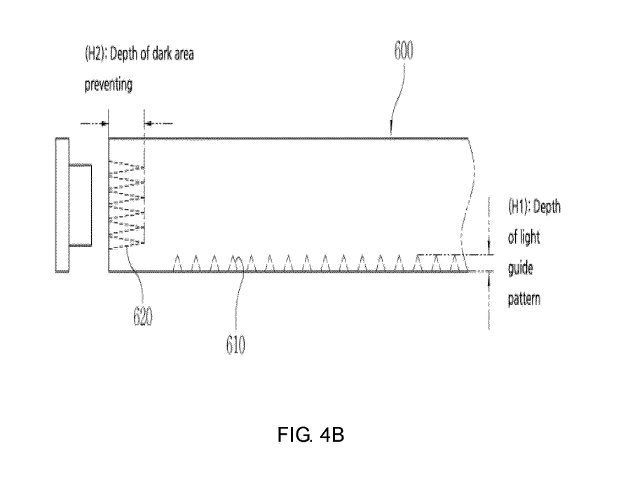

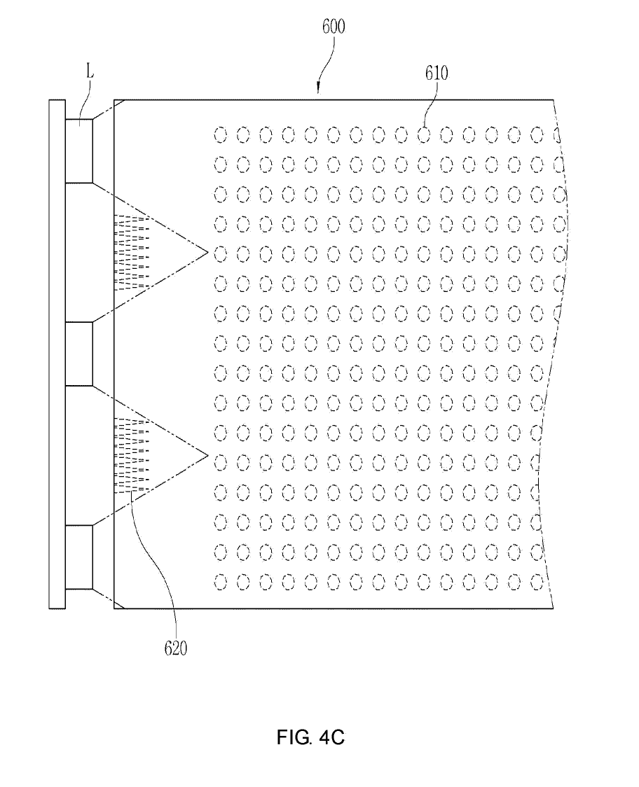

FIGS. 4A through 4C are a perspective view, a cross-sectional view, and a planar view, respectively, of a backlight unit, illustrating a light guide plate 600 and LED light sources (L) according to the Embodiment 2 the present invention.

Referring to FIGS. 4A through 4C, the backlight unit according to the Embodiment 2 of the present invention is identical to the backlight unit depicted in FIG. 1A through 1C except those facts that a plurality of dark area-preventing patterns 620 shall be formed on an incidence plane of the light guide plate 600 corresponding to the gap between the LEDs (L) and the depth direction of the dark area-preventing patterns 620 is perpendicular to the depth direction of the light guide patterns 610.

When the dark area-preventing patterns 620 are formed as such on the incidence plane of the light guide plate 600 corresponding to the gap between the LEDs, only a small amount of light may have an intense light emitting effect due to the dark area-preventing patterns 620 having a sufficient depth in a dark area at which a small amount of lights arrive. Thus, brightness in the dark area may be compensated and accordingly, a more uniform brightness may be obtained without an occurrence of the dark area.

Although conical-shaped dark area-preventing patterns formed in a direction identical to or perpendicular to the depth direction of the light guide patterns 610 are depicted in the foregoing Embodiment, the shape, number, and arrangement of the dark area-preventing patterns may be modified as circumstances require. A brief description will be provided hereinafter.

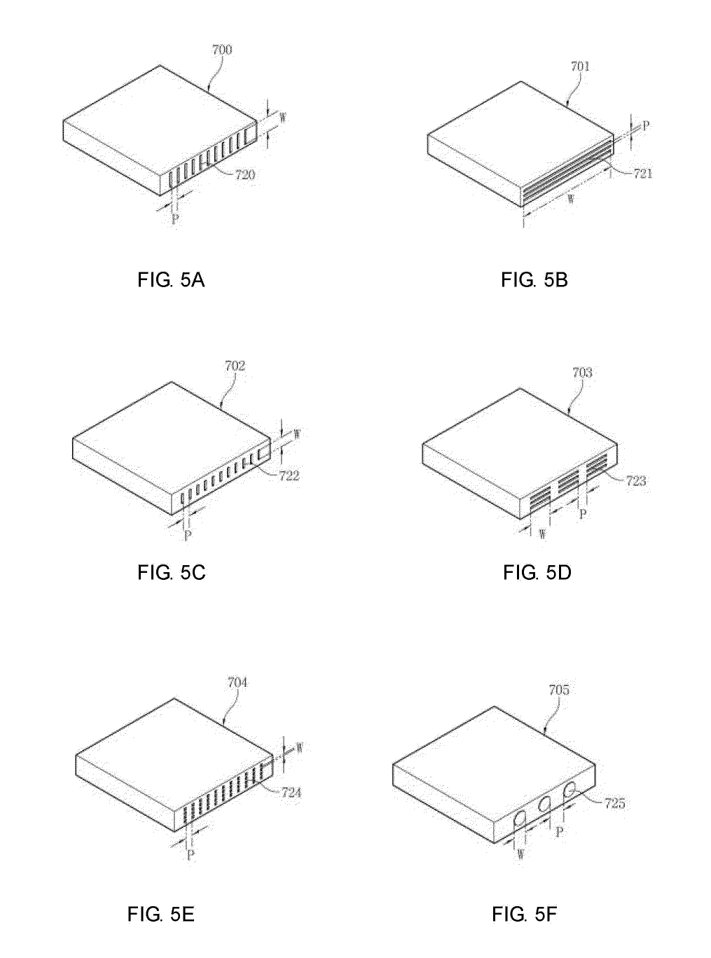

FIGS. 5A through 5F are illustrates another example of dark area-preventing patterns in a light guide plate according to the present invention.

Referring to FIGS. 5A through 5F, the shape, number, and arrangement of the dark area-preventing patterns (720 through 725) in light guide plates indicated (700 through 705) may be liberally modified to be, for example, a multi-faceted cone, cylinder, straight line, dotted line or curve.

Here, when an excessive number of the dark area-preventing patterns (720 through 725) are formed, an issue of a hot spot may occur. Thus, it may be required to adequately adjust the width (W) and pitch (P) of the dark area-preventing patterns (720 through 725) to prevent it.

Although several Embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A backlight unit, comprising:
a plurality of LEDs disposed on a bar-shaped circuit board and separated from one another at a predetermined interval; and
a light guide plate having a plurality of light guide patterns formed on one portion of the light guide plate that reflect, refract, or scatter lights incident from the LEDs to disperse the light in numerous directions and having a plurality of dark area-preventing patterns formed at a position corresponding to the gap between the LEDs to prevent a dark area between the LEDs,
wherein the dark area-preventing patterns are engraved with a relatively greater depth than that of the light guide patterns to reflect, refract, or scatter again a light passing through the dark area among lights dispersing in the numerous directions by the light guide patterns, to compensate for brightness in the dark area, and to prevent an occurrence of the dark area.

2. The backlight unit of claim 1, wherein the gap between the LEDs has a size greater than or equal to the width of an LED.

3. The backlight unit of claim 2, wherein the dark area-preventing patterns are formed at an edge of the light guide plate corresponding to the gap between the LEDs to a depth direction identical to that of the light guide patterns.

4. The backlight unit of claim 2, wherein the dark area-preventing patterns are formed on an incidence plane of the light guide the plate corresponding to the gap between the LEDs to a depth direction perpendicular to that of the light guide patterns.

5. The backlight unit of claim 3, wherein the dark area-preventing patterns are formed at a position departing from a radiation angle across which the lights incident from each LED spread and reach.

6. The backlight unit of claim 3, wherein the dark area-preventing patterns are formed in a blank space present between a portion of the light guide patterns and the edge of the light guide plate or formed at a position covered by a bezel provided around a border when assembling a backlight unit.

7. The backlight unit of claim 1, wherein when the light guide patterns are engraved, the dark area-preventing patterns are formed as the engraved pattern having a depth greater by a factor of greater than or equal to two than that of the light guide patterns.

8. The backlight unit of claim 1, wherein when the light guide patterns are embossed, the dark area-preventing patterns are formed as the engraved pattern having a depth greater than or equal to 100 μm.

9. The backlight unit of claim 1, wherein the dark area-preventing patterns are formed using at least one of laser processing, hot stamping, injection molding, extrusion, and ultrasonic machining.

10. The backlight unit of claim 4, wherein the dark area-preventing patterns are formed at a position departing from a radiation angle across which the lights incident from each LED spread and reach.

11. The backlight unit of claim 4, wherein the dark area-preventing patterns are formed in a blank space present between a portion of the light guide patterns and the edge of the light guide plate or formed at a position covered by a bezel provided around a border when assembling a backlight unit.
